(19) United States
(12) Patent Application Publication
(10) Pub. No.: US 2025/0222358 A1
(43) Pub. Date: Jul. 10, 2025

(54) VISUAL GAME EDITOR SYSTEM

(71) Applicants: Cheng-Yang YEH, Taipei City (TW); Yi-Ming TIEN, Taipei City (TW); Sung-Lin KU, Taipei City (TW)

(72) Inventors: Cheng-Yang YEH, Taipei City (TW); Yi-Ming TIEN, Taipei City (TW); Sung-Lin KU, Taipei City (TW)

(21) Appl. No.: 18/430,730

(22) Filed: Feb. 2, 2024

(30) Foreign Application Priority Data
Jan. 10, 2024 (TW) 113101076

(51) Int. Cl. A63F 13/60

(52) U.S. Cl. CPC A63F 13/60; A63F 2300/6009

(57) ABSTRACT

The present disclosure relates to a visual game editor system comprising a game editor, a conversion module and a script editing module. The game editor is used by a creator to design and build a game content. The conversion module is used to provide a proprietary game data format through which the conversion module converts the game content to a proprietary game format to fit different game platforms. The script editing module is used to provide an event-based script editor, which allows the creator to edit the game content by setting conditions and values in plain text through the event-based script editor of the script editing module. In this disclosure, the game editor writes the game content in a non-programmable way.

### BACKGROUND OF THE DISCLOSURE

### Technical Field

The present disclosure relates to an editor system, more particularly relates to a visual game editor system.

### Description of the Related Art

In the process of developing and producing games with existing technologies, professional programmers are required to write codes to complete the programming process, which is a significant barrier for creators who are interested in producing games but do not have the programming skills. In addition, the command structure used by different game platforms is also different, which often leads to complicated and repetitive development and editing operations if the developed game is to be shelved on different game platforms.

Existing an indie game engine includes an attribute system, a character state machine system, a behavior system, a script system, a map/environment system, an AI system, a script editing tool, a data editing tool, a map editing tool, a scenario editing tool, a battlefield editing tool, a character image editing tool, a traditional literature dictionary, a resource library, and a user cell, with the attribute system including a character attribute, an item attribute, an NPC attribute and skill attribute, and the data editing tool editing content includes character data, item data, military branch data, terrain data, strategy data and store data. This disclosure produces and prepares the maps, plots, characters, skills, item settings and other resources according to the rules of the game, and we can verify the effect of the game on the PC, the verified game can be directly generated through the TRGAME game production tools android, Ios, Win32 and other platforms, and through the pipeline to publish, to overcome the problems of long development cycle, high technical difficulty, and the difficulty of controlling the development cost of the similar games.

The aforementioned an indie game engine characterized in that the engine includes an attribute system, a character state machine system, a behavior system, a script system, a map/environment system, an AI system, a script editing tool, a data editing tool, a map editing tool, a scenario editing tool, a battlefield editing tool, a character image editing tool, a traditional literature dictionary, a resource library, and a user cell. The behavior system determines how the game is performed and the behavior system is connected to a graphics engine and a sound engine, the map/environmental system contains terrain conditions, monsters, NPCs, buildings, and world-related units, the AI system is used to determine how monsters will fight with the characters, the script editing tool generates in-game script content in the form of commands, the content edited by the data editing tool includes character data, item data, military branch data, terrain data, strategy data, and store data; the map editing tool is divided into a scenario editing tool and a battlefield editing tool; the scenario editing tool adopts a 45-degree perspective for editing the movement attributes of the scene; the battlefield editing tool adopts the God's eye view angle for editing the terrain of the battlefield, which corresponds with the terrain data in the data editor; the traditional literature dictionary and the AI system for determining how monsters fight in the game. The traditional literature dictionary and the traditional literature related keyword resource library provide creation, search, content recommendation, cell formation, data collection, and virtual reality presentation, and the user cell supports modules for cell creation, geographic location search, discussion boards, and a user account backstage database.

The above technical field is similar to the present disclosure, which is a solution for a game RPG engine. Cited Reference 1 aims at a game development solution for creators, not from the perspective of game developers. Moreover, the effects of “event-based script editing” and “AI script generation and stereogram maker” in Cited Reference 1 can achieve the effect of developing a game quickly.

Existing a method of editing the script of an indie game with a quick custom editor includes the steps of: reading the basic attribute configuration of the game as a priority; reading the most basic instruction fields and information, and saving them in the xml format; reading the eex and eex_new files for editing to open, search, edit and save the most basic script; checking whether there is a file or not, then editing directly; opening the file if there is a file; editing the file for adding, deleting, and changing, and checking script editing instructions to control, edit and save the script; checking whether there is a file, if there is no file, then edit directly, if there is a file, then open the file; editing the file by adding, deleting, and changing, checking the script editing instructions, to control the direction of the script, and copy, paste, and delete the instructions; going through all the instructions to check whether there is any error in the instructions, and whether the format of the instructions is correct; saving it as a brand-new eex or eex_new file; and encrypting the binary file. The present disclosure improves the flexibility of script writing and has a clear structure, which is easy to modify and simple to operate. The file protection adopts AES and RSA double encryption technologies to protect the security of the script.

The aforementioned an editing method of a quick custom editor for scripts of indie games, including the following specific steps: (1) read the basic attribute configuration of the game first, the basic attribute configuration of the game includes character, level, number of scripts, and pictures of treasures; (2) read the most basic command fields and information, and save them in xml format; (3) read eex and eex_new files for editing to open, search and edit the most basic script; (4) check whether there is a file, and if there is no file, then edit directly, and if there is a file, then open the file; (5) add, delete, and change the file, check the script editing instruction, the control of the direction of the script, and copy, paste and delete the instruction; (6) go through all the instructions to check whether there are errors in the instructions, and whether the instruction format is correct; (7) save the file as a new eex or eex_new data file; (8) encrypt a binary file to protect the file using AES and RSA double encryption technologies.

The above technical field is similar to the present case, which is able to construct script files in json and xml formats, and requires code writing to complete script editing, and there is no database design to generate a complete game. The game editor in Cited Reference 2 provides a complete set of editing tools including but not limited to text, music, pictures, interactive videos, 2D animation, 3D animation, etc., and with the database generation, the complete game can be generated by dragging and dropping on the game editor.

Existing a rendering engine, an implementation method and a production tool based on a 3D web game are provided, the rendering engine comprises: a parsing and loading module for reading, decompressing and parsing the information required for concrete rendering from a customized file format finally outputted by a workflow, realizing non-blocking parsing; a scene management module for implementing field of view culling, scene object traversal classification, picking and mouse event dispatch and rendering process management; a camera and control module for implementing scene roaming and realizing camera event dispatching; and a camera and control module for implementing scene roaming and realizing camera event management. a scene management module for implementing field of view culling, scene object traversal categorization, pick and mouse event dispatch, and rendering process management; a camera and control module for implementing scene roaming and camera animation; and a rendering module for rendering all the information needed for an object, including rendering geometries, materials, animations, and transformation matrices. The authoring tools include export plug-ins, custom file formats, 3D editors, special effects authoring tools, and UI authoring tools. The present disclosure has the advantages of good cross-platform and scalability, and significant reduction of the game development cycle and threshold.

The aforementioned a 3D web game based rendering engine, which is characterized in that a parsing and loading module that reads, decompresses, and parses the information required for concrete rendering from the custom file format of the rendering engine that is ultimately outputted by the workflow, realizing non-blocking parsing; a scene management module that realizes field-of-view culling, scene object traversal categorization, picking up and mouse events, and rendering process management; a camera and control module that realizes scene roaming and camera animation, as well as special effects, keyframe animation, model actions, camera animation, and special effects, keyframe animation, model actions, and camera animation; and camera and control module that realizes scene roaming and camera animation. camera and control module for scene roaming and camera animation, and combining effects, keyframes, model actions, camera animation, and sound, and then adjusting them on the timeline to get the final effects and skills; rendering module for rendering all the information needed to render an object, including rendering of geometries, materials, animations, and transformation matrices; and the rendering module for rendering all information needed to render an object, including rendering of geometry, materials, animations, and transformation matrices; and the rendering of a scene object. The rendering module also includes a solid module, a light shading module, a texture module, an animation module, a post-effects module, and a pathfinding module; the solid module contains all of the geometry, texture, animation, and transformation matrix information needed to render an object; the light shading module is used to compile and collect the lighting in a scene; the texture module is used to achieve the final colors and light reflections of the model; the animation module is used to create the final color of the model; the animation module is used to create the final color and light reflections of the model; and the animation module is used to create the final color of the model. The animation types supported by the animation module include vertex animation, skeleton animation, keyframe animation, particle animation, and combination animation; the post-effects module should be used for full-screen special effects; the pathfinding module is used to automatically confirm the character's path of movement in the scene to generate pathfinding data; the specific process of the parsing and loading module includes: decompressing, then parsing a custom file and checking the time of this parsing; when this parsing takes place, the time of this parsing is reduced by the time of parsing; the time of this parsing is reduced by the time of parsing; the time of this parsing is reduced by the time of parsing. The specific process of parsing and loading module includes: decompressing, then parsing a customized file and checking the time of parsing; when the parsing time is within the set threshold, the next decompression process will be started directly, and when the parsing time exceeds the set threshold, it will wait for the next frame to start parsing.

The above technical field is similar to that of the present disclosure, except that the editor in Cited Reference 3 is not realized by visualization, which is a patent unrelated to the present disclosure.

Existing a storybook corresponding to a user interaction in a virtual game environment is created. A computing device receives user input to control the movement of a virtual character within a virtual gaming environment and records a time sequence of events from the virtual gaming environment without user input. Each event represents an interaction of the virtual character with the virtual gaming environment, and each event includes a corresponding image and corresponding text describing the corresponding event. After recording, a sequence of analog pages corresponding to the sequence of events is presented to the user. Each analog page includes a corresponding recorded image of the corresponding event and a corresponding text describing the event. For at least a subset of the simulation pages, the user modifies the corresponding text. An output file is generated that includes the sequence of simulation pages modified by the user.

The aforementioned a method for creating a storybook for user interaction with a virtual gaming environment, comprising: at least one computing device having one or more processors and memory for storing one or more programs configured to be executed by the one or more processors: receiving user input for controlling the actions of a virtual character within the virtual gaming environment; recording a time sequence of events from the virtual gaming environment without user input, wherein each event represents an interaction of the virtual character with the virtual gaming environment, and each event includes a corresponding image and a description of the virtual character, and each event includes a description of the virtual character, and receiving user input to control the actions of a virtual character within the virtual gaming environment; recording, in the absence of user input, a time sequence of events from the virtual gaming environment, wherein each event represents an interaction of the virtual character with the virtual gaming environment, wherein each event comprises a corresponding image and corresponding text describing the corresponding event; presenting to the user, after the recording, a sequence of simulation pages corresponding to the time sequence of the events, wherein each simulation page comprises at least a portion of a corresponding recorded image of the corresponding event and comprises at least a portion of a corresponding text describing the corresponding event; receiving user input to modify at least a portion of the corresponding text describing the corresponding event for at least a subset of the simulation pages; and generating a file comprising a user-modified sequence of the simulation pages, wherein the user is able to type in alternative text to modify at least a portion of the corresponding text the describes the corresponding event

The above technical field is different from that of the present disclosure, which is the same as Cited Reference 3, wherein the editor is not realized by visualization, and Cited Reference 4 is a patent unrelated to the present disclosure.

Existing a visualized game logic editing method and system, combining and connecting all the components in a component library according to the operation logic in the form of a tree structure, that is to say, forming a series of commonly used operation logics in the game into a tree structure by means of a program, and managing all the operations, judgments, and data as nodes of the tree, and drawing them out and responding to the corresponding operations through a game logic editing interface, providing a logic structure for the planner, which only needs to select the corresponding operations according to the required logic, choose the logic according to the required logic, and select the corresponding operations accordingly. The game logic editing interface is provided to draw and respond to the corresponding operations, to provide a logical framework for planners, just according to the required logic to select the corresponding content options, the use of different nodes to control the content of the items of the options are combined with each other, so that users can also change the same node control items of the content of the items of the options in order to utilize the same components to achieve different functions, the logic of the game performance can easily be demonstrated through the interface, and planners can be self-explanatory through the interface. The game logic can be easily displayed through the interface, allowing the planners to realize the logical structure of the game by themselves through the editing system, reducing the reliance on programmers, improving the reusability of the code, and avoiding the code can only realize the same function of the same component repeatedly.

The aforementioned a visual game logic editing method, characterized in that it comprises the steps of: S101: detecting whether there is an input of a run command, performing step S102 if yes, then not performing any operation otherwise; S102: activating a preconfigured editor software, calling up a pre-stored library of components and controlling the editor software to display an editing interface of the game logic; the library of components includes function elements, action elements, condition elements, data source elements, value data elements, preset value elements, variable elements, and operator elements; the editor software is configured with all the elements in the library grouped and connected in a tree structure; the game logic editing interface is bound to all the elements in the library, and the game logic editing interface is configured with a root node control item, and a plurality of parent node controls configured under the root node control, at least one sub-node control configured under each of the parent node controls, and at least one sub-node control configured under a portion of the sub-node controls; at least one parameter variable option is provided within each of the sub-node controls and each of the sub-node controls; each of the parameter variable options comprises a different plurality of content options that are bound to the corresponding component in the library; S103: the game logic editing interface is bound to all components in the library; and S103: detecting whether there is an editing instruction input to each node control item and/or each parameter variable option in the game logic editing interface; if so, controlling the corresponding node control item to be opened, calling the corresponding component according to the editing instruction, generating the corresponding logic code, and saving it in a logic code library, and completing the game logic editing; if not, maintaining the display of the current game logic editing interface.

The above technical field is similar to that of the present disclosure, which is a visualization of the script presentation and not a visualization of the operation, but a visualization of the open code writing. Therefore, it is difficult for creators to carry out more complicated development work and script design. In the present disclosure, the “event-based script editing” does not need to write scripts by itself, the creator can use text description and convert it into scripts directly.

Existing a triggers-based visualized game level editing method comprises the steps of: (A) accessing a game development database, updating and obtaining game level design resources and data; (B) providing a human-machine interaction interface, the human-machine interaction interface comprising a mechanism editing area, a level editing area and a parameter configuration and activity area; and (C) loading the game level design resources and data into the user-configured components in the machine operation editing area and the level editing area, translating at least one of the tested machine operation assembly components into a level data format file and transferring it to a game level editing tool for creating or updating a level. The system includes: a first module for accessing a game development database; a second module for providing a human-machine interaction interface; and a third module for exporting the level data format file. The present disclosure significantly reduces game level development costs and improves code reusability and maintainability.

The aforementioned a triggers-based visualized game level editing method characterized in that the method includes the following steps: (A) accessing a game development database to update and obtain game level design resources and data; (B) providing a human-machine interface comprising a mechanism editing area, a level editing area, and a parameter configuration activity area, wherein the mechanism editing area comprises sequentially connected input event elements, mechanism judgment elements, trigger elements, and output event elements, the level editing area comprising mechanism combination elements associated with elements in the mechanism editing area, the parameter configuration activity area comprising parameter combination elements associated with elements in the mechanism editing area, and the parameter configuration activity area comprising parameter combination elements associated with elements in the mechanism editing area, and the parameter configuration activity area is associated with both the machine operation editing area and the level editing area and has access to the corresponding game level design resources and data; (C) loading the game level design resources and data into the user-configured machine operation editing area and the level editing area, translating at least one of the tested machine operation assembly components into a level data format file and transferring it to the game level editing tool for creating or updating a level.

The above is similar to the present disclosure in that it visualizes the flow of the levels, but it does not have visual editing, and still requires program code input. In the present disclosure, the “event-based script editing” does not require writing scripts at all, and the creators can use textual descriptions and convert them into scripts directly.

Existing a program content generation tool is operated in the steps of: generating a graph of existing game content through image analysis; generating a Symmetric Markov Random Field (SMRF) model based on the graph; and automatically generating new game content based on the SMRF model through an iterative Artificial Intelligence (AI) process.

The aforementioned a game development platform comprising a machine which comprises: a processing circuitry; a non-transitory computer-readable storage medium configured to store a game application program and further instructions for operations, wherein, when executed by the processing circuitry, the processing circuitry performs operations comprising: generating a graph of existing game content through image analysis; generating a symmetric Mav Random Field (SMRF) model based on the graph; and automatically generating new game content based on the SMRF model through iterative artificial intelligence (AI).

The above technical field is similar to that of the present disclosure, and this cited reference relates to a game content generation method based on artificial intelligence, which is similar to the feature of the present disclosure “AI script generation and stereogram maker”, but the rest of this cited reference is irrelevant to the present disclosure.

Existing a method and system for dynamic music composition are disclosed. An emotion is assigned to one or more musical themes, and a game vector is associated with the emotion. The one or more musical themes are mapped to the game vector based on the emotion. A musical composition is generated based on the game vector and the desired emotion.

The aforementioned a method of dynamic music creation comprising: (a) assigning an emotion to one or more musical themes; (b) linking a game vector to the emotion; (c) mapping the one or more musical themes to the game vector based on the emotion; and (d) generating a musical composition based on the game vector and the desired emotion.

The above technical field is similar to that of the present disclosure, and this cited reference relates to a method for generating game content (music) based on machine learning, which is similar to the feature of the present disclosure “AI script generation and stereogram maker”, but the rest of this cited reference is irrelevant to the present disclosure.

Existing a video game development platform relates to the components of an application such as a video game, including source code, graphics, sound and animation, and a marketplace in which any of the foregoing content is traded for currency, tokens, credits or grants. These components can then be combined to produce video games using game editing and creation tools. Users can create and edit their own games or base their games on pre-existing games created by other users, and can share their games with others. Game components can be bought, sold, traded or otherwise distributed through online marketplaces.

The above technical field is similar to that of the present disclosure, wherein this cited reference relates to an editor for a 3D game, rather than a visualization scheme for converting creations to games as provided in the present disclosure, and thus this cited reference is different from the present disclosure.

Existing a computer-implemented method for generating a mini-game includes recording game play of a game on a computerized game system and receiving a signal to generate the minigame, and suspending play of the game in response to the signal. The method includes identifying a start point and an end point of the minigame from the recorded game, and using the start point and the end point to generate an executable instruction to enable play of the minigame. The method includes storing the generated executable instruction in the distribution system. The distribution system includes at least one server that can access the minigame to access the generated executable instruction. Furthermore, the selection of the generated executable instruction enables the interactive game of minigames to be played.

The above technical field is similar to that of the present disclosure, which is a method of generating a mini-game in a game, but it is unrelated to the present disclosure.

In view of the aforementioned deficiencies of the prior art, how to provide a visual game editor system to enable the creators to quickly design and build game content through a visual interface, and easily adapt to different game platforms demands immediate attention and feasible solution in the industry.

### SUMMARY OF THE DISCLOSURE

In view of the aforementioned shortcomings, it is a primary objective of this disclosure to overcome the shortcomings of the prior art by providing a visual game editor system, which includes a game editor, a conversion module and a script editing module, a game editor provided for a creator to design and create a game content. The conversion module provides a proprietary game data format and converts the game content into a proprietary game format by the proprietary game data format to fit different game platforms. The script editing module provides an event script editing, so that the creator can use the event script editing of the script editing module to set the configuration conditions and numeric values by a plain text approach to edit the game content. Wherein, the game editor can write the game content in a non-programming way.

To achieve the aforementioned objectives, the present disclosure provides a visual game editor system which includes a development module that provides a development process including the steps of: logging in a game editor to create new items, select a game type, design a game content, eventualize a script configuration, test and preview, announce a game, and share the game in a personal website for social communication and distribution, etc.

To achieve the above objective, the present disclosure provides a visual game editor system with a game editor for the use of performing the interface operation including but not limited text input, resource dragging, etc.

To achieve the above objective, the game editor of the visual game editor system of the present disclosure includes but not limited to the functions of importing required resources, adding and writing plots, designing game interaction mechanisms, importing and setting up branching routes, setting up and creating databases, producing animation effects, handling special events triggered by clicks, an AI plot generator, an AI 3D plotter, a batch editing, a multi-language integration, a multiplexer, a plug-in, collaborative development, a real-time online testing, an editing tool, a personal website, a game player and a game output.

To achieve the above objectives, the visual game editor system of the present disclosure has a game interactive design mechanism that can divide the game interaction process into a plurality of execution timing and a plurality of execution contents corresponding to the plurality of execution timing, import and set up the branch path to allow a creator to import the branch path in order to set different endings and events of a game, and the batch editing allows creators to make large-scale editing to game content. The multi-language integration is provided for translating the text descriptions in the game into multiple languages. The plug-in allows creators to use functional modules in the community to encapsulate and share functions with other creators. The real-time online testing enables the game editor to support the sharing of test links for real-time online game testing, and the personal website is used to provide a personal website setting function for creators to share developed games and scripts.

To achieve the above objectives, the proprietary game data formats of the visual game editor system of the present disclosure include but not limited to the plot data format, element data format and flow data format.

To achieve the aforementioned objective, the proprietary game data format included in the visual game editor system of the present disclosure includes a constructing specification for each data format setting file, and it includes but not limited to a JSON data exchange format.

To achieve the aforementioned objective, the visual game editor system of the present disclosure has a plot data format that is designed as a serial content of a patchwork game, and the serial content includes an element, an event, a process, a special effect, etc.

To achieve the aforementioned objective, the plot data format of the visual game editor system of the present disclosure further includes a plot module, a template module and a plug-in module.

To achieve the aforementioned objective, the plot module of the visual game editor system of the present disclosure includes data of a life cycle, an element, a special effect, etc.

To achieve the aforementioned objective, the template module of the visual game editor system of the present disclosure is applied to the plot module.

To achieve the aforementioned objective, the plug-in module of the visual game editor system of the present disclosure has a special functional or purposeful plot.

To achieve the aforementioned objective, the element data format of the visual game editor system of the present disclosure includes a picture element, a background element, a text element, a button element, an animation element, a Spine element, an audio element, a movie element and a component element.

To achieve the aforementioned objective, the process data format of the visual game editor system of the present disclosure includes a data/parameter process, an element process, a condition process, a plot process, a bind process, a system process, a process component, a plug-in process, an audio process and an automatic playback process.

To achieve the above objectives, the event script editing of the visual game editor system of the present disclosure generates the game script and content by the methods including but not limited to condition, numerical operation, addition, deletion, etc.

To achieve the aforementioned objective, the event-based script editing of the visual game editor system of the present disclosure includes but not limited to a plot editing, an element editing and a process editing.

To achieve the aforementioned objective, the element editing of the visual game editor system of the present disclosure saves the element data in a specific field of the plot through inserting, deleting and changing the element.

To achieve the aforementioned objective, the process execution of the process editing of the visual game editor system of the present disclosure includes a life cycle, an element event, a component element process and a component process.

To achieve the above objectives, the visual game editor system of the present disclosure further includes a database and a server, the database is provided for storing, managing and processing the game content and user data, and the server is provided for processing various requests of the system including but not limited to data modification and inquiry.

To achieve the above objectives, the visual game editor system of the present disclosure includes a distribution system, which can be integrated with a personal website of the game editor and provided for a creator to set the distribution ratio and provide its own game to other creators for distribution.

### BRIEF DESCRIPTION OF THE DRAWINGS

FIG. 1 is a schematic view of a visual game editor system of the present disclosure;

FIG. 2 is a schematic view of a visual game editor system with a development process of the present disclosure;

FIG. 3 is a schematic view of a visual game editor system in which the game editor completes the plot data format, sets up the game playback test, and adds and writes the plot in accordance with an embodiment of the present disclosure;

FIG. 4 is a schematic view of a visual game editor system with a game editor provided for filling elements into a plot in the data format of the configuration file when adding and writing the plot in accordance with an embodiment of the present disclosure;

FIG. 5 is a schematic view of a game editor of a visual game editor system of an embodiment of the present disclosure when performing game interaction design mechanism;

FIG. 6 is a schematic view of a basic interface of a game editor included in the visual game editor system of the present disclosure;

FIG. 7 is a schematic view of an element editing interface of a game editor included in the visual game editor system of the present disclosure;

FIG. 8 is a schematic diagram of the resource import interface of the game editor of the visual game editor system of the present disclosure.

FIG. 9 is a schematic view of an AI plot generation interface of a game editor included in the visual game editor system of the present disclosure;

FIG. 10 is a schematic view of a batch editing interface of a game editor of the visual game editor system of the present disclosure;

FIG. 11 is a schematic view of a login interface of a game editor included in the visual game editor system of the present disclosure;

FIG. 12 is a schematic view of a creator's game creation overview interface of a game editor included in the visual game editor system of the present disclosure;

FIG. 13 is a schematic view of an interactive design interface of a game editor included in the visual game editor system of the present disclosure; and

FIG. 14 is a schematic view of an event scripting interface of a game editor of the visual game editor system of the present disclosure.

### DESCRIPTION OF THE PREFERRED EMBODIMENTS

The present disclosure is described in detail in the preferred embodiments with reference to the accompanying drawings. The drawings used herein are for illustrative and explanatory purposes only, and may not be the actual proportion and precise configuration of the invention after implementation. Therefore, the relationship between the proportion and configuration of the attached drawings should not limit the scope of the patent of the present disclosure in actual implementation,

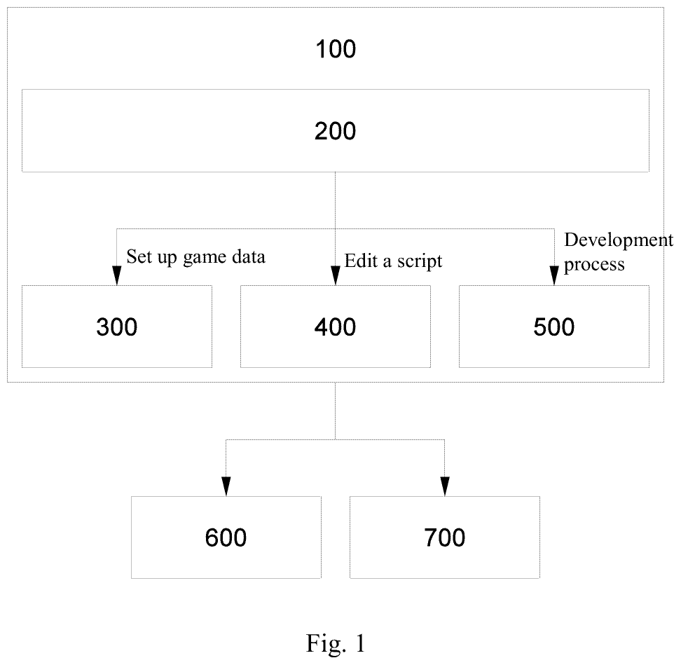

With reference to FIG. 1 for a visual game editor system of the present disclosure, the visual game editor system 100 includes a game editor 200, a conversion module 300 and a script editing module 400. The game editor 200 is provided for a creator to design and create a game content. The conversion module 300 is used for providing a proprietary game data format, and the conversion module 300 converts a game content into a proprietary game format through a proprietary game data format to fit different game formats. The script editing module 400 is used for providing an event-based script editing, and the creator sets the condition and numerical value in plain text mode through the event-based script editing of the script editing module 400 to edit the game content. Wherein, the game editor 200 writes the game content in a non-programming way.

In detail, the game editor 200 is preferably a game development tool that requires no programming and allows creators to design and build game content in an intuitive manner. The proprietary game data format of the conversion module 300 is a highly flexible data format that ensures that game parameter settings can be seamlessly applied to a variety of gaming platforms to enable easy game uploading and publishing. The event-based script editing of the script editing module 400 enables creators to transform the game content and script they want to create into operable event sequences by setting conditions and numerical values in plain text, without requiring the need of writing complex codes. The combination of this core technology framework provides creators with a complete non-programming development tool that allows them to create games quickly, easily and without technical background, and ensures that these games can be easily launched on different platforms.

In this way, the visual game editor system 100 of the present disclosure can provide a tool for creators and originators (including but not limited to YouTubers, novelists, comics, etc.) to easily transform their creative works into games, including but not limited to novels, animations, comics, etc., without the need for programming knowledge or development experience. In other words, the visual game editor system 100 of the present disclosure will dramatically increase the feasibility of game creation and enable more people to participate and enjoy the fun of creating games without the need for technical background.

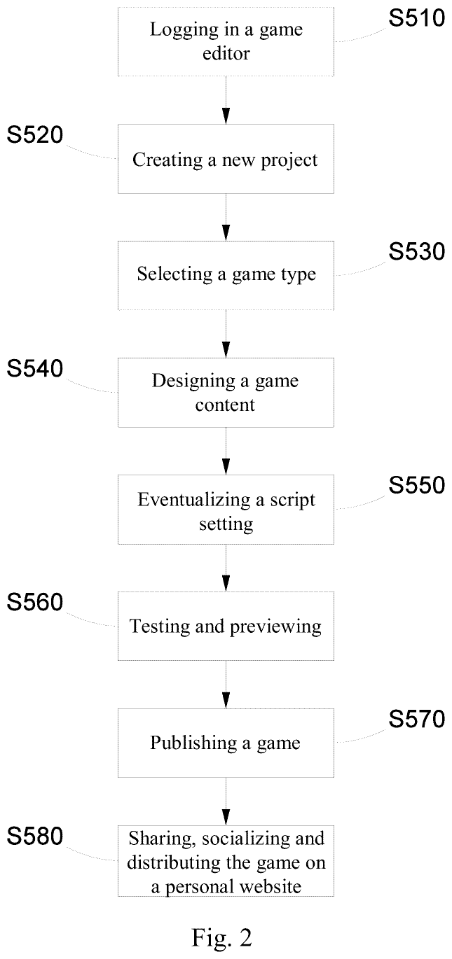

In FIG. 1, the visual game editor system 100 of the present disclosure further includes a development module 500, which is used to provide a development process. In FIG. 2, the development process includes the steps of: (S510) logging in a game editor; (S520) creating a new project; (S530) selecting a game type; (S540) designing a game content; (S550) eventualizing a script setting; (S560) testing and previewing; (S570) publishing a game; and (S580) sharing, socializing and distributing the game on a personal website.

The above steps are described as follows:
S510: Logging in a game editor: Creators will first need to login to the game editor and use their account or sign up for a new account.
S520: Creating a new project: Creators can choose to create a new game project and assign a name and description to it.
S530: Selecting a game type: Creators can select one of the default game types from the list, or define a game type to start defining the basic characteristics of the game.
S540: Designing a game content: Creators enter the content design phase of the game, where they can add characters, scenery, storylines, and set the rules and goals of the game, all with simple drag-and-drop and point-and-click operations that require no programming.
S550: Eventualizing a script setting: In the game content, creators can eventualize a script, i.e. to set up interactive events in the game. These events can be triggered according to specific conditions and numerical values, and can be set through text. For example, the creators can define a conversation event to be triggered when a protagonist reaches a certain location, or change the game progress when certain conditions are met.
S560: Testing and previewing: Creators can preview the game at any time to make sure it is running properly and meets their expectations. They can simulate the operation of players in the game to check whether events are triggered as expected.
S570: Publishing a game: Once the game is fully designed and tested, creators can choose to publish the game. The system will automatically convert the game into a format suitable for various game platforms in order to be shelved and published.
S580: Sharing, socializing and distributing on a personal website: Creators can share links to their games on their personal websites after they have completed the game and invite other creators to participate or provide feedback, or to distribute the game. In addition, the creators can use social media platforms to publicize and share their games to expand their audience.

Through the above embodiments, the simplicity of the present disclosure for game development is highlighted, allowing creators to focus on their creativity without having to worry about technical details.

The game editor 200 is the core of the present disclosure and provides an intuitive interface for creators to create games. The game editor 200 adopts the operation of optimized user experience (UX), wherein the creators can use the interface of the game editor 200 to operate the interface by means including but not limited to text input, and drag-and-drop of resources (images, music, videos, etc.), and can effectively use the drag-and-drop method to quickly complete the application and arrangement of game resources, so as to enable the creators to easily get started with game editing and complete the game creation. The game editor 200 can include the following main functions:

Importing required resources: Creators can import required game resources and materials, including but not limited to images, music, videos, etc. through the game editor 200 to enrich the game content.

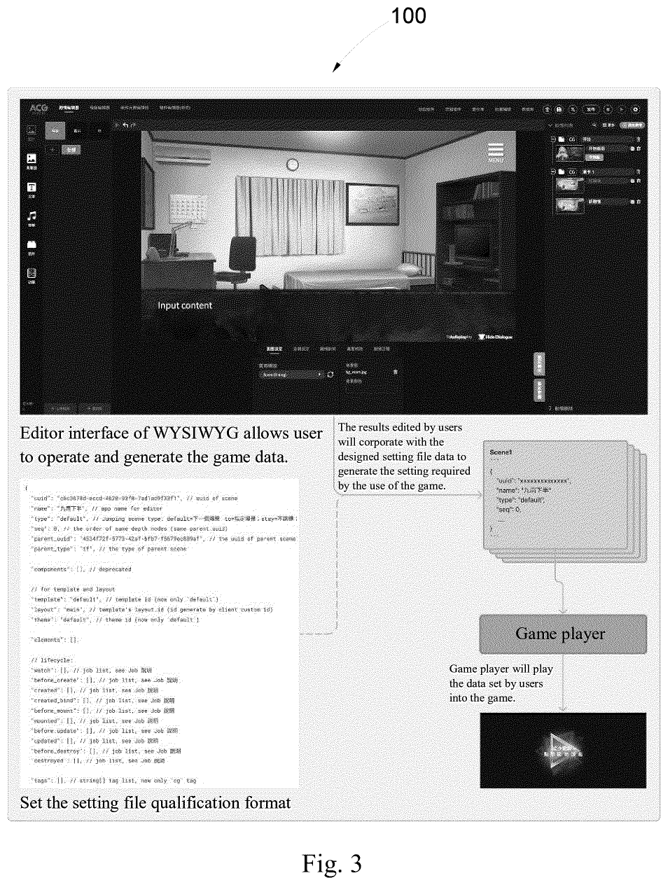

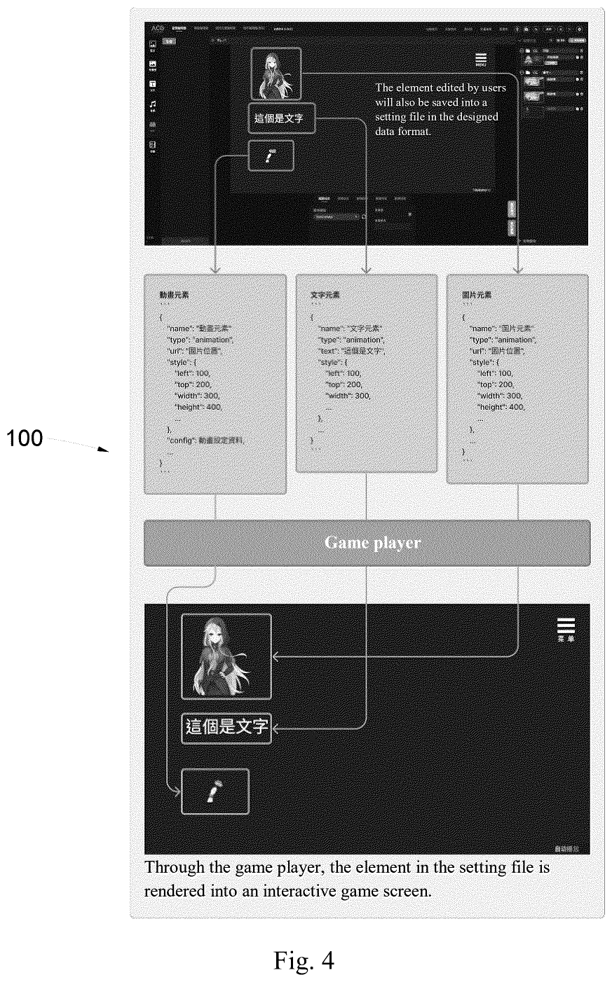

Inserting and writing plots: Creators can insert plots and write plots, including but not limited to dialogues, scripts, interactions, and other plots and settings in the game plots. FIG. 3 shows an example of the process of inserting and writing plots through the game editor 200, completing the formatting and setting of plot data and conducting game playback tests. Thus, the creators can add various elements to each plot, and these elements will also be filled into the plot data in the format of the setting file data. The process embodiment is shown in FIG. 4.

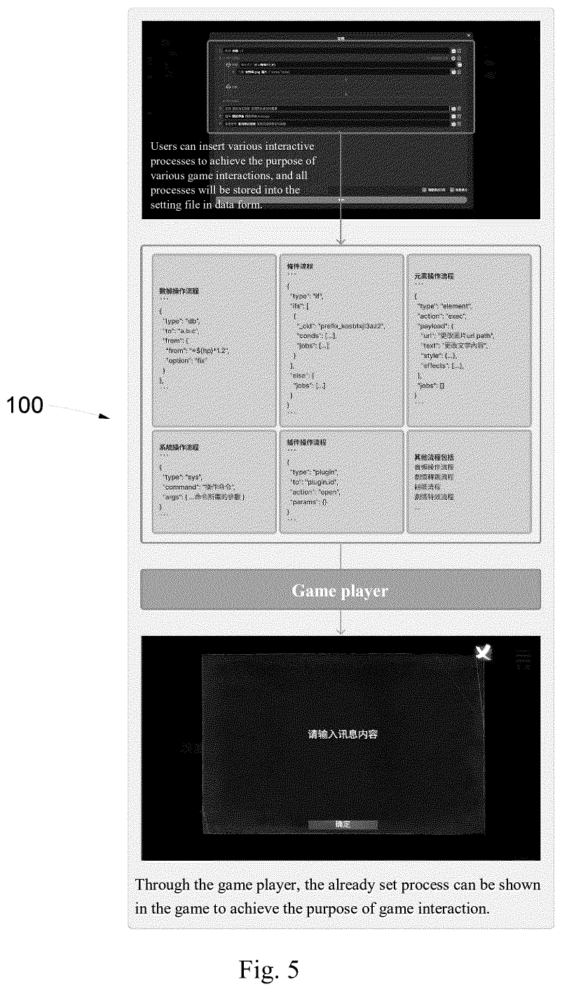

Game interaction design mechanism: The game editor 200 divides the interaction process of the game into “execution timing” and “execution content”. The game editor 200 contains a plurality of execution contents, and the creator can execute the execution contents set by the creator in the corresponding execution timing to complete the game interaction design. The completed game interaction design will directly generate the related game setting data, and compile the game plot data, and can directly conduct the game play test. An example of this process is shown in FIG. 5.

Importing and setting branch path: game editor 200 allows creators to import the branch path, which means that creators can set the occurrence of different game endings and events, so that players can actually play the game with different choices that lead to different game endings or events.

Setting and creating database: The game editor 200 can set and create databases in a game, including but not limited to character attributes, items, game rules, etc.

Production animation effect: The game editor 200 provides an animation production tool, so that creators can add eye-catching animation effects to enhance the visual attraction of the game.

Processing the clicked and triggered special event: Creators can set special events, when special elements are clicked, in order to achieve more interactivity.

AI plot generator: Based on the artificial intelligence technology, the game editor 200 provides the AI auto-generation of game plots, which can be directly adopted by the creators and can save the creators' time and effort.

AI 3D plotter: Based on the artificial intelligence technology, the game editor 200 provides an AI 3D plotter to assist creators to generate 3D drawings of the game and converts 2D drawings into 3D drawings, thus providing a more efficient game development process.

Batch editing: The game editor 200 provides a batch editing function to allow creators to quickly make large-scale editing to game content, such as batch editing of in-game characters, words, etc., or batch adjustments of paths and parameters, to save time for post-development and testing. Take the script content batch editing as an example, you can import and export the content through Excel to complete the batch editing.

Multi-language integration: The game editor 200 can translate the text description of the game into multiple languages to realize the fast language switching in the game. In an embodiment of translating the text description of the game into multiple languages, the multi-language translation can be accomplished by importing and exporting the text description of the game into multiple languages through Excel.

Multiplexer: game editor 200 provides a tool for reusing the elements or functions to improve the efficiency of producing the game content.

Plug-in: The game editor 200 provides plug-ins, so that creators can use the functional modules in the social group to package and share the functions to other creators, and other creators can directly introduce the plug-ins of the packaged functions and use them in the game editor 200.

Collaborative development: The game editor 200 supports a multiplayer collaboration, allowing a plurality of creators to edit and design games at the same time.

Real-time online testing: The game editor 200 supports the sharing of test links for real-time online game testing, so that creators can share game test links with test subjects for real-time online testing.

Editing tool: The game editor 200 provides an editing tool including but not limited to text, music, picture, interactive movie, 2D animation and 3D animation editing tools, thus providing a full range of game content creation.

Personal website: The game editor 200 provides creators a user account with their own personal website, on which the creators can share their developed games and scripts, as well as sell their own games and those of other creators through the subsequent distribution system, thus establishing a total space service from creators' personal website setup, game creation to sales.

Game player and game output: The game editor 200 provides a game player, supports a plurality of multi-output platforms and formats, including but not limited to HTML5, IOS, Android, Windows, macOS, host platform (such as PlayStation, Xbox, Nintendo Switch, etc.) and WebGL, so that the games can be published and run smoothly on different browsers and game formats.

The game editor 200 allows creators to easily realize their game creations while providing an interface that corresponds to a variety of tools and features to make the game development process more efficient and smoother. Embodiments of the operation interface of the game editor 200 and the corresponding icons are described below:

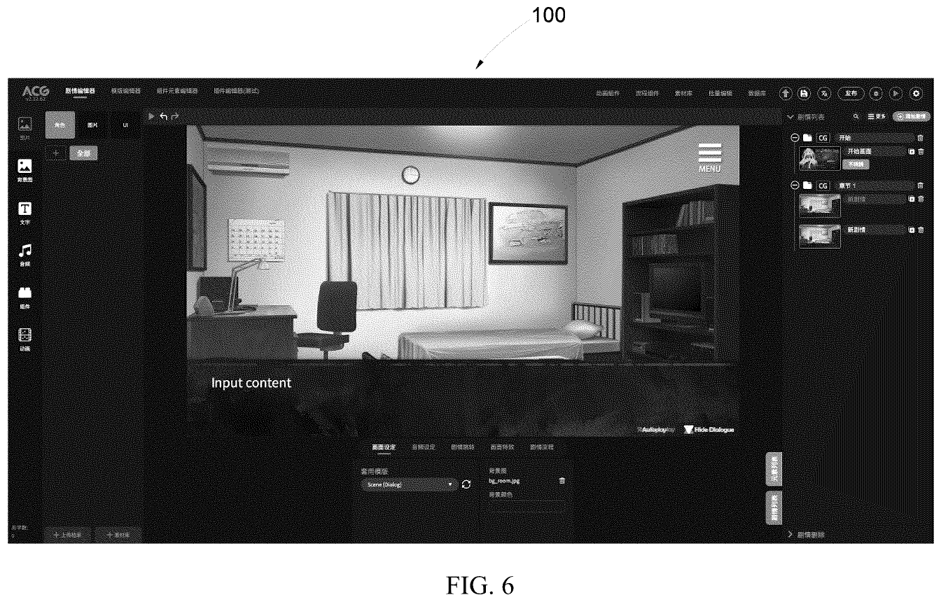

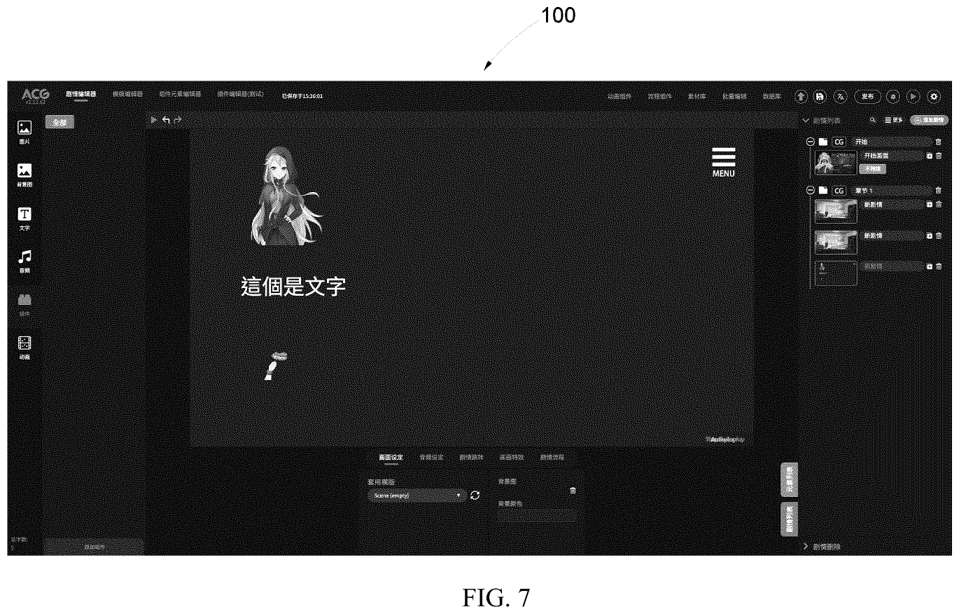

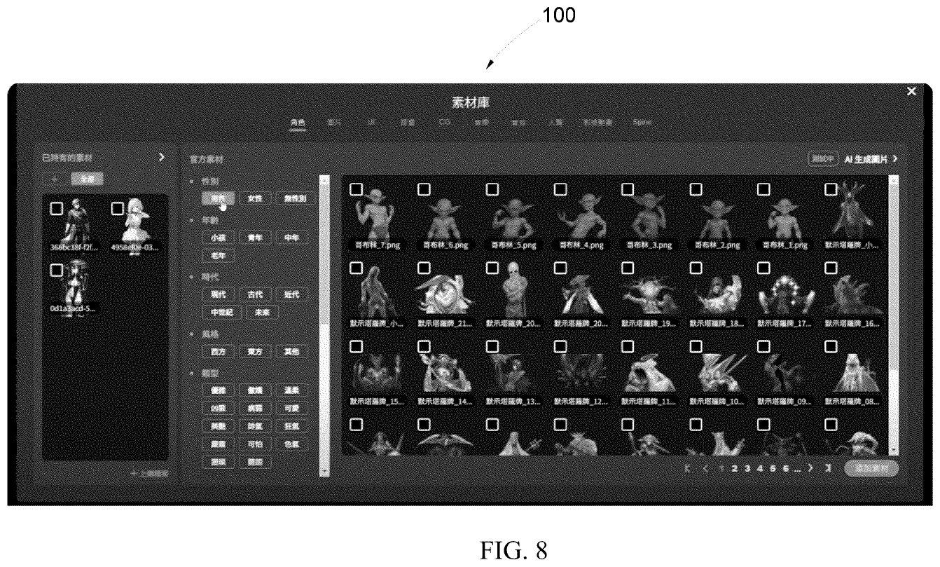

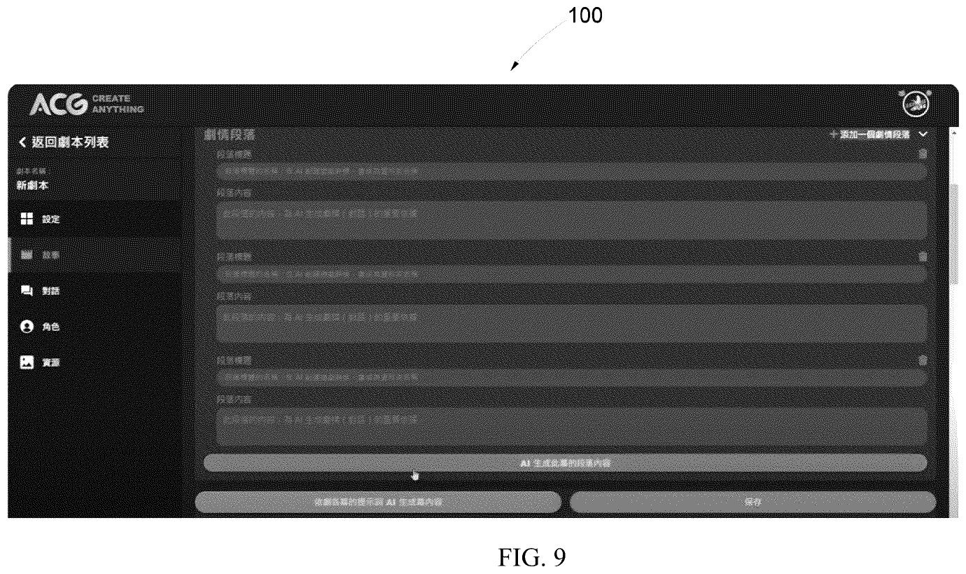

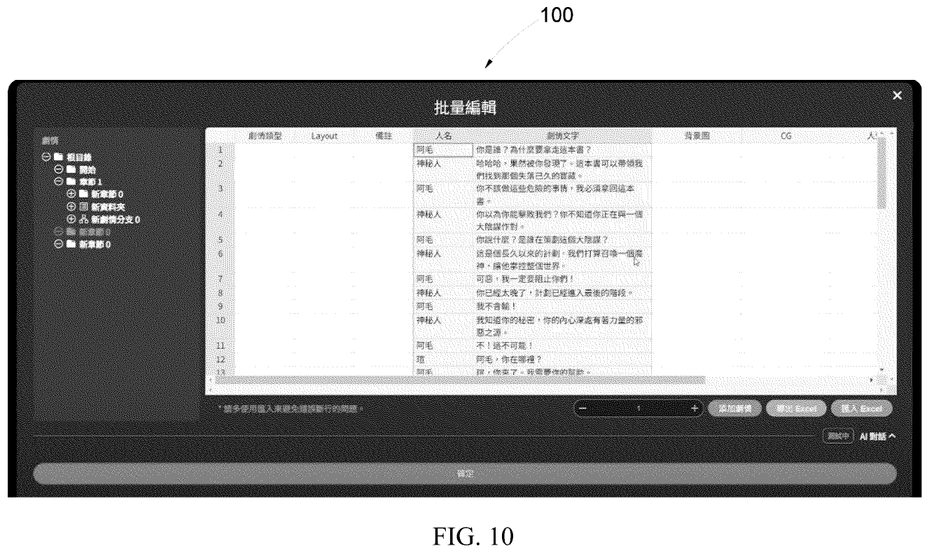

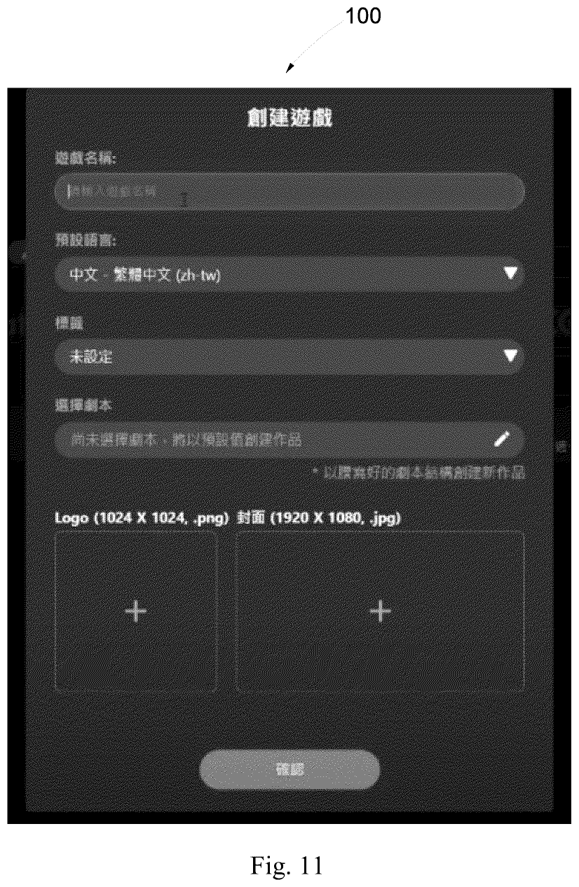

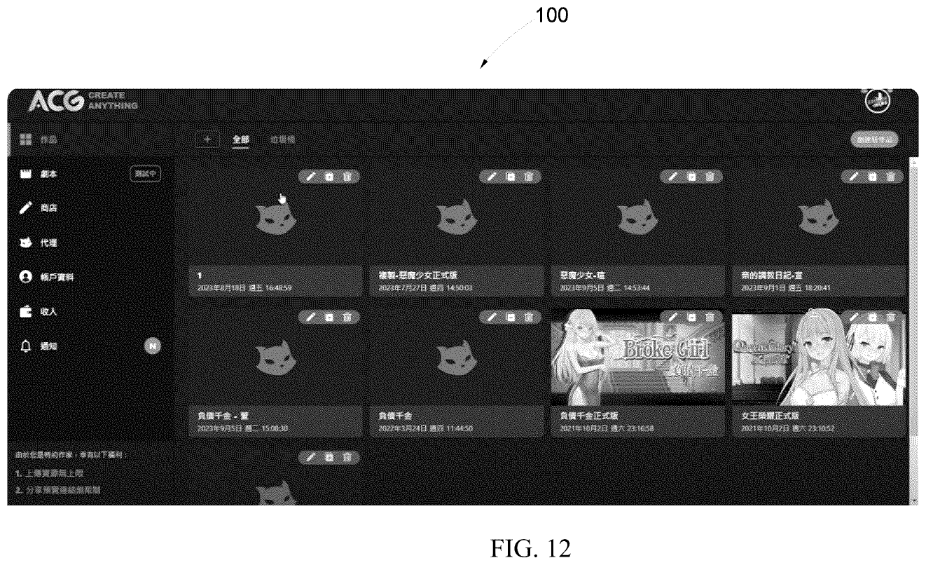

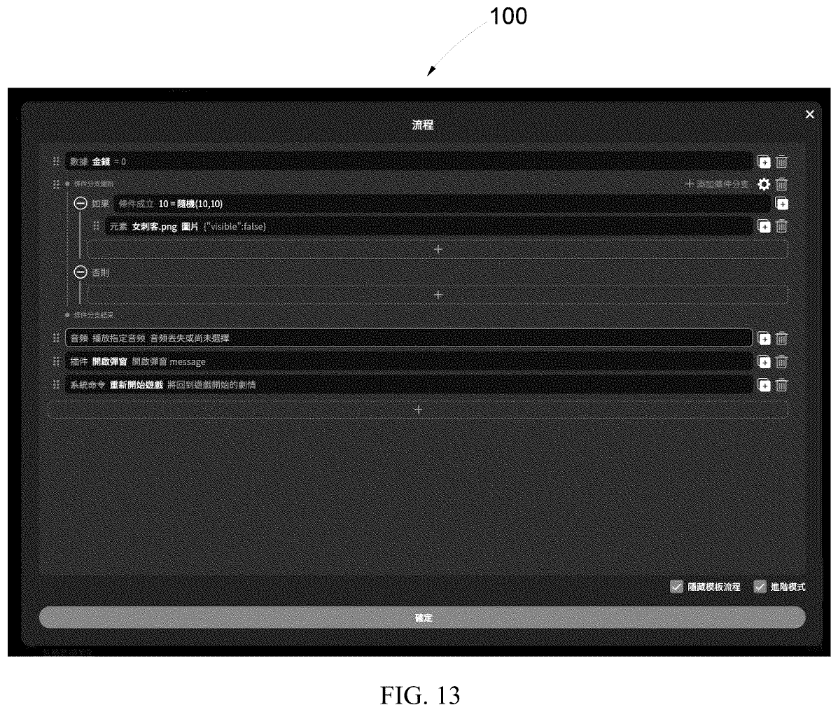

Refer to FIG. 6 for the schematic view of a basic interface of a game editor 200 included in the visual game editor system 100 of the present disclosure, FIG. 7 for the schematic view of an visual game editor system 100 with an element editing interface of the game editor 200 of the present disclosure, FIG. 8 for the schematic view of the visual game editor system 100 with the resource import interface of the game editor 200 of the present disclosure, FIG. 9 for the schematic view of an AI plot generation interface of a game editor 200 included in the visual game editor system 100 of the present disclosure, FIG. 10 for the schematic view of a batch editing interface of a game editor 200 of the visual game editor system 100 of the present disclosure, FIG. 11 for the schematic view of a login interface of a game editor 200 included in the visual game editor system 100 of the present disclosure, FIG. 12 for the schematic view of a creator's game creation overview interface of a game editor 200 included in the visual game editor system 100, and FIG. 13 for the schematic view of an interactive design interface of a game editor 200 included in the visual game editor system 100 of the present disclosure.

The visual game editor system 100 of the present disclosure includes a proprietary game data format including but not limited to a game data format, a plot data format, an element data format and a process data format. Wherein, the proprietary game data format has a specification of constructing each data format setting file, which includes but not limited to the JSON data exchange format, to ensure that the designed data can be supported by most of the game platforms and programming languages.

### 1. Game Data Format:

The game data format is designed for setting the configurations and basic data needed for a game, and the game player presents the game to the players through these configurations and game data. The content includes but not limited to a game name, a default language, a game theme style, a template, a plug-in, icon, a game version, an editor version, a supported language list, an environment setting, a variable, etc.

### 2. Plot Data Format:

To facilitate creators to edit the game, the plot data format is designed to a serial content of a patchwork game that contains elements, events, processes, and special effects for the purpose of presenting the plot content.

Depending on the purpose of use, the plot data format is subdivided into three modules: a plot module, a template module, and a plug-in, each of which corresponds to a different purpose of use:

### (1) Plot Module:

It mainly contains lifecycles, elements and special effects. Creators can put the data of elements, processes and special effects into the plot through the game editor to achieve the purpose of performance. Depending on how the plot changes (jumps), it can be divided into the following categories:
Next: According to the plot sequence (seq), it will play the next plot after a plot ends;
Chapter: It facilitates creators to categorize and manage the plots;
Designate: It will play the designated plot after a plot ends;
Stay: The plot will not jump, until a process is initiated to achieve the jumping effect;
Condition/Self-defined condition: The specified data condition needs to be met before entering the specified plot;
Option: It will automatically pop up a plot type of an option after a plot ends.

### (2) Template Module:

The data structure is similar to the structure of the plot module, but instead of being used directly in the game as in the case of the plot module, the data is applied to the plot module, so that the plot can be used differently on the basis of the elements, processes and special effects set in the template module. The purpose of this level of design is to minimize unnecessary repetitive operations when designing similar plots, simply by applying the specified template, and then modifying/adding specific elements, processes and special effects in order to change the data of the plot.

### (3) Plug-In Module:

It is similar to the plot module, but it has a special functional or purposeful plot, such as a pop-up window, a setting window, etc. The plug-in function needs to be enabled or disabled through a process.

### 3. Element Data Format:

Element is a basic unit of plot rendering, which is used to present the picture that a plot should show, and thus constructs the element data format. Elements can be categorized into the following categories according to their purpose:
Picture element: It is the element used for rendering specified pictures;
Background element: It is the element used for rendering background pictures, wherein the background pictures can be divided into two types: background and CG;
Text element: It is the element used for rendering text;
Button element: It is the element used for rendering buttons;
Animation element: It is the element used for rendering frame animation;
Spine element: It is the element used for rendering Spine format animation;
Audio element: It is the element to be set for playing this plot, which is not rendered, and can be categorized as music, sound effects, and vocals;
Movie element: It is the element to be set for playing a movie;
Component element: It is the element composed of a plurality of elements, which is conducive to reuse in different plots.

### 4. Process Data Format

Game interaction is the major difference between movies and games, so in order to better allow the creators to design the details of the interaction, the present disclosure designs the execution timing and the execution of the content (flow) separately. In terms of timing, the present disclosure designs lifecycles within the plot and allows processes to be inserted to all lifecycles, thus allowing creators to have finer control when the content needs to be executed.

With regard to the execution content, the present disclosure also designs different types, so that creators can carry out different interactions:
Data/parameter process: The operation value changes depending on the data;
Element process: The operation element changes according to different elements, and the operable elements have different attributes; and the plot can be enriched by this process;
Condition process: Whether the conditions are valid or not is determined according to the data, before performing other process operations;
Plot process: It is the process used for jumping to a specified plot;
Bind process: It is the process for binding an event (such as clicking, suspending, etc.) to a specified element, and if an event is triggered, the process set by the creator will be performed;
System process: It is the process that can control the officially set data (such as saving a file, reading a file, etc.);
Process component: It assembles the process into a component, which can be used repeatedly at any execution timing;
Plug-in process: It is the process that controls the ON and OFF of the plug-in;
Audio process: It is the process that controls and operates audios;
Automatic playback process: It controls the basis for the jumping of playback and the number of seconds delayed in the case of automatic playback.

The event-based script editing of the script editing module 300 of the present disclosure is provided for creators to use the set condition and numerical operation, to convert the game content and scripts they wish to implement into judgmental formulas. Instead of having to learn and write cumbersome codes, creators can implement their ideas into in-game events by simply typing in text descriptions. This key feature enables game creators to translate their ideas into game events and interactions in a very intuitive way, without the need for in-depth knowledge of programming.

In detail, after the data format required by the game content is designed, it is necessary to edit the interface and operation of these game content data, therefore, through the event-based script editing, the aforementioned “proprietary game data format” of the elemental event settings for the life cycle of the game (including the beginning of the game, the end of the game, as well as a variety of elemental interactions in the game to set up the script to complete the life cycle event-based script editing, therefore, in the actual construction of the game operation, it can better control the interactions, control, and continuity of different scripts (e.g., in the game plot, besides letting the creators focus on the performance of the current plot, they can control the interactions of each plot through the event-based script editing, such as the transition of changes in the fading in and fading out of the game scene). Thus, in practice, it is possible to set the event to fade out before the destruction of another episode A, and set the event to fade in before the rendering of the plot of another episode B, so as to achieve the interaction of the plot performance, and to better present the performance of the game).

The event-based script editing includes but not limited to plot editing, element editing process editing, etc.

### 1. Plot Editing:

Through creating or selecting a plot data and inserting the elements to be used in this plot by the game editor 200, and then proceeding to the plot setting, plot jumping, special effects when jumping, and process setting, so as to complete the production of multiple plots, these series of plots can be played through the game player in a game that can be played interactively.

### 2. Element Editing:

Element data editing saves element data in a specific field (hereafter referred to as the element field) in one of the plots by inserting, deleting, and changing elements. All of the element information saved in these elements will determine how the game player renders the plot as it renders through the lifecycle. Not all elements in a plot are included, and some elements will be taken from template elements for the purpose of sharing purpose.

### 3. Process Editing

Process execution can be divided into the following:

(1) Life cycle:
Before creating a plot: It is the timing for executing the process before creating a plot;
After creating a plot: It is the timing for executing the process after creating a plot;
Before rendering an element: It is the timing for executing the process before rendering an element;
After rendering an element: It is the timing for executing the process after rendering an element;
Before destroying a plot: It is the timing for executing the process before destroying a plot;
After destroying a plot: It is the timing for executing the process after destroying a plot;
Before updating a plot: It is the timing for executing the process before updating a plot;
After updating a plot: It is the timing for executing the process after updating a plot;
Monitoring data: It is the timing of executing the process after updating data.

### (2) Element Event:

Clicking an element: It is triggered by pressing and releasing any button of a mouse, or touching or separating the button by a finger;
Entering a cursor: It is triggered by a slide-in of any button of a mouse or a touch of a finger;
Leaving a cursor: It is triggered by a slide-out of any button of a mouse or a separation of a finger;
Inputting through a cursor: It is triggered by pressing any button of a mouse or touching by a finger;
Outputting through a cursor: It is triggered by pressing any button of a mouse or a separation of a finger;
Moving a cursor: It is triggered by sliding in the cursor through a mouse or a touch of a finger with a movement.
   (3) Component element process: It is the timing of triggering the execution of the process when rendering the component element;
   (4) Component process: It is the timing of triggering the execution of the process when executing the component process;

Through the process editing interface, processes can be inserted to the above execution timings, and when finally through the rendering of the game player, the game player will execute the required processes according to each execution timing (e.g. life cycle).

In this method, the present disclosure designs a data format used by the game content, including game, plot, element and process data, a data editing interface is provided to set and complete a series of plot data, finally plays this series of data into a game through a game player.

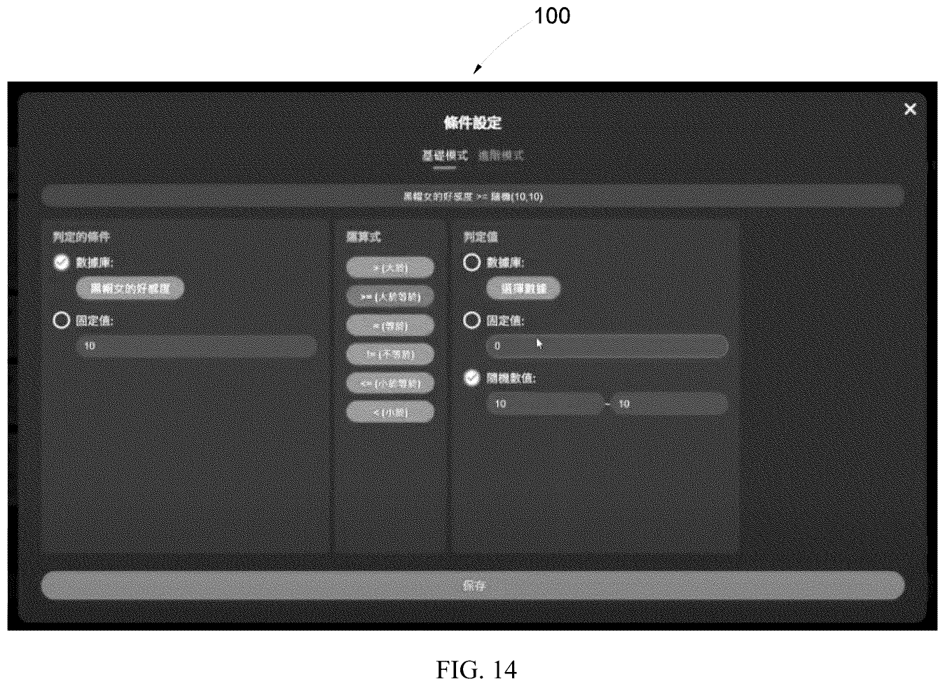

In addition, the event-based script editing further provides a strong support to Excel Macros, making the large-scale data operation much easier. Creators can easily perform various operations, including but not limited to conditions (True/False), value operations Select, Insert, Delete, etc., to quickly generate game scripts and content. FIG. 14 shows the schematic view of the eventualized script interface of the game editor 200 of the above embodiment.

Taking the “card withdrawal” function which is a must for mobile games nowadays as an example, this function can be realized through event-based script editing. First of all, creators can use Excel to input the card data, then set the timing and operation of each card withdrawal through Excel Macros, and finally, the creators only need to input the conditions to realize the card withdrawal and present the final “card withdrawal” mechanism to the players. This event-based script editing feature allows creators to easily implement complex game interactions while saving time and effort without the need of learning in-depth programming skills.

In FIG. 1, the visual game editor system 100 of the present disclosure further includes a database 600 and a server 700. The database 600 is for storing, managing and processing the game content and user data, and the server 700 is for processing various request of the system, including but not limited to modifying data, executing data inquires, etc. to ensure the smooth operation of the system.

The structure of the database 600 can be selected according to actual needs, either a traditional relational database or a NoSQL database to meet different information management needs. Meanwhile, the server 700 can be selected from different options such as a local server or a cloud server according to the deployment requirements to ensure operational performance and scalability.

In addition, the present disclosure further has a strong local processing capability, which can be realized by performing the required algorithms on the creator or the creator's device. This flexibility enables the system to run in different environments and to select the most suitable operation method according to the actual needs, ensuring the efficiency and scalability of the game development process.

The visual game editor system 100 of the present disclosure further has the following features and applications:

### 1. Distribution System:

In the personal website of the game editor 200 of the present disclosure, a distribution system can be integrated, which can provide creators with the ability to set a distribution ratio and offer their own games to other creators for distribution. Thus, for a creator, his/her personal website will be able to sell his/her own games and those of other creators, thus creating a centralized sales model.

2. Proprietary Game Design Format with Extensibility:

The proprietary game data format of the present disclosure has a highly flexible game data format that can fulfil the needs of different game platform vendors, enabling game developers to easily apply game content to various platforms without the need for re-development or tedious setup work. This extensible format greatly simplifies cross-platform deployment of game development, saving time and resources.

### 3. Creator Content Gaming:

The present disclosure has a powerful gaming conversion feature that allows creators to turn their creations, such as novels, animations, comics, etc., directly into games without having to rewrite the plot or code. This allows creators to quickly and painlessly transform their ideas into interactive game experiences, thus expanding their audience and market.

### 4. No Need to Write Program Codes:

The game editor 200 of the present disclosure provides a simple and intuitive game editor that enables creators to easily create game materials without the need of writing program codes, and the eventualized script editor also provides the effect of creating scripts without the need of writing program codes. This allows creators without any programming experience to participate in game development and create impressive game content.

### 5. Multi-Language Function:

The present disclosure supports a multiple of languages, which can add a multi-language support to the game at the stage of generating games to cater to the needs of players and markets in different countries. This feature can directly translate the text description (e.g. plot dialogues) inputted by the creators into other languages automatically, so that the multi-language version of the game can be generated without the need for translation.

### 6. Real-Time Online Testing and Adjustment:

The game editor 200 of the present disclosure provides a real-time online testing function, which enables game developers to test the game effects in real time during the game development process. Meanwhile, with the game editor 200 of the present invention, the creator can edit the game content in real time during the testing stage and review the testing effect immediately, which improves the testing efficiency and ensures the quality and performance of the game.

Compared with traditional game development systems, the present disclosure has the following advantages:
1. No programming knowledge required: The present disclosure enables creators to easily produce games without requiring programming knowledge, thus greatly lowering the barrier to the entry into the field of game development, and allowing more creators to participate and create their own games.
2. Editing tool: The game editor 200 of the present disclosure includes an editing tool to allow creators to easily produce game materials including but not limited to texts, music, pictures, interactive movies, 2D animations, 3D animations, etc. This expands the creators' freedom of creativity.
3. Multi-language support: The multi-language integration and multi-language support of the game editor 200 of the present disclosure allows the game to be successfully distributed in different countries around the world. Creators can generate multi-language versions of the game by simply inputting the text once, without the need for tedious translations.
4. Real-time online testing: The game editor 200 of the present disclosure includes real-time online testing, which allows creators to test game effects in real time during the game development process. This helps to identify and solve problems in advance, thus improving the game quality.
5. Proprietary game data format: The proprietary game data format of the present disclosure ensures that high extensibility of the data format can easily adapt to different game platform requirements. This allows game developers to release games on different platforms quickly without the need for heavy re-development or configuration work.
6. Event-based script editing: The event-based script editing of the present disclosure makes the game development extremely fast. Creators can use simple text types to directly convert text into actual judgment without requiring tedious programming. At the same time, the Excel Macro function allows creators to easily execute various operations and improve the development efficiency.

In summation of the description above, the advantages of the present disclosure resides in its innovative and highly configurable tools that make game development easier and freer, while ensuring effective cross-platform deployment and providing multi-language support to meet the needs of different markets around the world. This system not only saves time, but also increases the efficiency and creativity of game development, enabling more people to participate in game development.

While the ideas and technical characteristics of the present disclosure have been described by means of specific embodiments with the purpose of enabling those having ordinary skill in the art to understand the contents of the present disclosure and implement the present disclosure accordingly, it is to be understood that the disclosure is not limited to these embodiments. To the contrary, numerous modifications and variations could be made thereto by those skilled in the art without departing from the scope and spirit of the disclosure set forth in the claims.

What is claimed is:

1. A visual game editor system, comprising:
a game editor, provided for a creator to create and set up a game content;
a conversion module, for providing a proprietary game data format and converting the game content into a proprietary game format through a proprietary game data format to fit different game platforms; and
a script editing module, for providing an event-based script editing, the creator setting up a condition and a numerical value to edit the game content in a plain text mode through the event-based script editing of the script editing module;
wherein, the game editor writes the game content in a non-programming way.

2. The visual game editor system according to claim 1, further comprising a development module for providing a development process, and the development process comprising the steps of: logging in the game editor; creating a new project; selecting a game type; designing a game content; setting up an event-based script, testing and previewing, and publishing a game, and sharing, socializing and distributing the game on a personal website.

3. The visual game editor system according to claim 1, wherein the game editor carries out an interface operation in a way including but not limited to text input and resource dragging.

4. The visual game editor system according to claim 1, wherein the game editor includes but not limited to the functions of importing required resources, inserting written plots, performing game interaction design mechanisms, importing and setting branch paths, setting and creating databases, providing a production animation effect, processing a triggered special event, an AI plot generator, an AI 3D plotter, a batch editing, a multi-language integration, a multiplexer, a plug-in, a collaborative development, a real-time online testing, an editing tool, a personal website, a game player, and a game output.

5. The visual game editor system according to claim 4, wherein the game interaction design mechanism allows the interaction process of the game to be divided into a plurality of execution timing corresponding to the plurality of execution contents respectively, and the introduction and setting branch path allows the creator to import the branch path to set different game endings and events, the batch editing allows the creator to make a large-scale editing of the game content, the multi-language integration is provided for translating the text description of the game into a plurality of languages, the plug-in allows the creator to use the function modules in social media groups to package and share the function to other creators, the real-time online testing allow the game editor to support the sharing of testing link for the real-time online game testing, the personal website provides a personal website setup function for creators to share developed games and scripts.

6. The visual game editor system according to claim 1, wherein the proprietary game data format includes but not limited to a plot data format, an element data format and a process data format.

7. The visual game editor system according to claim 6, wherein the proprietary game data format comprises a constructing specification for each data format setting file, which includes but not limited to a JSON data exchange format.

8. The visual game editor system according to claim 6, wherein the plot data format is designed as a serial content of a patchwork game, and the serial content comprises an element, an event, a process and a special effect.

9. The visual game editor system according to claim 6, wherein the plot data format further comprises a plot module, a template module and a plug-in module.

10. The visual game editor system according to claim 9, wherein the plot module comprises data of a life cycle, an element and a special effect.

11. The visual game editor system according to claim 9, wherein the template module is applied to the plot module.

12. The visual game editor system according to claim 9, wherein the plug-in module has a special functional or purposeful plot.

13. The visual game editor system according to claim 6, wherein the element data format comprises a picture element, a background element, a text element, a button element, an animation element, a Spine element, an audio element, a movie element and a component element.

14. The visual game editor system according to claim 6, wherein the process data format comprises a data/parameter process, an element process, a condition process, a plot process, a bind process, a system process, a process component, a plug-in process, an audio process and an automatic playback process.

15. The visual game editor system according to claim 1, wherein the event-based script editing generates the game script and contents by the method including but not limited to condition, numerical operation, insert and delete.

16. The visual game editor system according to claim 15, wherein the event-based script editing comprises but not limited to a plot editing, an element editing and a process editing.

17. The visual game editor system according to claim 16, wherein the element editing saves the element data in a specific field of the plot through inserting, deleting and changing the element.

18. The visual game editor system according to claim 16, wherein the process execution of the process editing comprises a life cycle, an element event, a component element process and a component process.

19. The visual game editor system according to claim 1, further comprising a database and a server, the database being provided for storing, managing and processing the game content and the user data, and the server being provided for processing various request of the system, including but not limited to modifying data and executing data inquiries.

20. The visual game editor system according to claim 1, further comprising a distribution system integrated with a personal website of the game editor, and provided for the creator to set a distribution proportion, and provide its own game to other creators for distribution.
